(19) United States
(12) Patent Application Publication
(10) Pub. No.: US 2026/0131861 A1
(43) Pub. Date: May 14, 2026

(54) VEHICLE BODY STRUCTURE

(71) Applicant: TOYOTA JIDOSHA KABUSHIKI KAISHA, Toyota-shi (JP)

(72) Inventor: Ryosuke FUKUI, Togo-cho (JP)

(73) Assignee: TOYOTA JIDOSHA KABUSHIKI KAISHA, Toyota-shi (JP)

(21) Appl. No.: 19/352,965

(22) Filed: Oct. 8, 2025

(30) Foreign Application Priority Data
Nov. 13, 2024 (JP) 2024-198604

(51) Int. Cl. B62D 25/08

(52) U.S. Cl. CPC B62D 25/085

(57) ABSTRACT

A vehicle body structure includes a motor unit, a framework member, a protruding portion, and a recessed portion. The motor unit is configured to be supplied with electricity and output a driving force for traveling. The framework member is integrally molded by die-casting and constitutes a framework of a vehicle, and includes a support portion that is placed on a rear portion side in a vehicle front-rear direction of the motor unit and configured to support a portion of the motor unit. The protruding portion is provided on the motor unit and protrudes toward the framework member. The recessed portion is provided in the support portion and opens on the side closer to the motor unit, and the protruding portion is fitted in the recessed portion.

### CROSS-REFERENCE TO RELATED APPLICATION

This application claims priority to Japanese Patent Application No. 2024-198604 filed on November 13, 2024, incorporated herein by reference in its entirety.

### BACKGROUND

### TECHNICAL FIELD

The present disclosure relates to a vehicle body structure.

### DESCRIPTION OF RELATED ART

Japanese Unexamined Patent Application Publication No. 2019-166916 (JP 2019-166916 A) discloses a structure of a junction box that can mitigate damage to a harness by being provided with a protruding portion that contacts a vehicle component earlier than the harness does when a motor unit moves backward in a frontal collision of a vehicle.

### SUMMARY

If a motor unit moves backward and falls in a frontal collision of the vehicle as described in JP 2019-166916 A, a component placed in front of the motor unit in a vehicle front-rear direction may fail to be completely crushed. On the other hand, from the viewpoint of safety in a frontal collision, an interval of a certain length is needed between the battery and the motor unit, which puts restrictions on the installed size of the battery.

The present disclosure is a vehicle body structure that makes it less likely that a component placed in front of a motor unit in a vehicle front-rear direction may fail to be completely crushed, and that can reduce the restrictions on the installed size of the battery.

A first aspect of the present disclosure relates to a vehicle body structure including a motor unit, a framework member, a protruding portion, and a recessed portion. The motor unit is configured to be supplied with electricity and output a driving force for traveling. The framework member is integrally molded by die-casting and constitutes a framework of a vehicle, the framework member including a support portion that is placed on a rear portion side in a vehicle front-rear direction of the motor unit and configured to support a portion of the motor unit. The protruding portion is provided on the motor unit and protrudes toward the framework member. The recessed portion is provided in the support portion and opens on the side closer to the motor unit, and the protruding portion is fitted in the recessed portion.

Here, "fitted" includes a state where there is a clearance between the two as in clearance fitting.

In the vehicle body structure of the above-described first aspect, the framework member that is integrally molded by die-casting and has the framework of the vehicle includes the support portion that supports a portion of the motor unit on the rear portion side in the vehicle front-rear direction of the motor unit. The support portion is provided with the recessed portion that opens on the side closer to the motor unit, and the protruding portion that is provided in the motor unit and protrudes toward the framework member is fitted in the recessed portion. Thus, as the protruding portion of the motor unit is fitted in the recessed portion of the support portion on the rear portion side in the vehicle front-rear direction of the motor unit, the motor unit can be efficiently prevented from falling in a frontal collision of the vehicle. Further, since a portion of the motor unit is supported by the support portion, the motor unit can be prevented from moving backward in a frontal collision of the vehicle. As the motor unit is thus supported on the rear portion side in the vehicle front-rear direction of the motor unit, a reaction force can be generated by the motor unit, which can reduce the likelihood that a component placed in front of the motor unit may fail to be completely crushed. That the motor unit does not move backward allows the interval between the battery and the motor unit to be shortened, so that the restrictions on the installed size of the battery can be reduced.

In the vehicle body structure of the above-described first aspect, the protruding portion may protrude toward an upper side in a vehicle-height direction. The recessed portion may open on the lower side in the vehicle-height direction.

In the vehicle body structure configured as described above, the protruding portion that protrudes toward the upper side in the vehicle-height direction is fitted in the recessed portion that opens on the lower side in the vehicle-height direction. Thus, the motor unit is supported by the recessed portion from the upper side in the vehicle-height direction, so that the motor unit can be prevented from falling in a frontal collision of the vehicle.

In the vehicle body structure of the above-described first aspect, the recessed portion may be provided on each side in the vehicle-width direction of the framework member.

In the vehicle body structure configured as described above, since the recessed portions are respectively provided on both sides in the vehicle-width direction of the framework member, the framework member can support the motor unit in a well-balanced manner.

In the vehicle body structure configured as described above, the framework member may be integrally molded so as to include a pair of right and left front side member parts respectively provided on both sides in the vehicle-width direction, right and left wheel arch parts respectively provided on outer sides in the vehicle-width direction of rear-side portions in the vehicle front-rear direction of the right and left front side member parts, and a cross-member part suspended between the right and left wheel arch parts. The recessed portion may be provided at a site where the front side member part and the cross-member part intersect.

In the vehicle body structure configured as described above, the recessed portion is provided at the site where the front side member part and the cross-member part intersect, which makes it possible to install the motor unit in a space between the right and left wheel arch parts and thereby improve the space efficiency. Moreover, since the recessed portion can be provided at a corner portion of a space region surrounded by the front side member parts and the cross-member part, the motor unit can be supported in a region where it does not interference with other member parts.

In the vehicle body structure configured as described above, the site of the intersection may be represented by an extended part that is extended from an inner face in the vehicle-width direction of the front side member part toward the inner side and extended from a front end face in the vehicle front-rear direction of the cross-member part toward the front side.

In the vehicle body structure configured as described above, the site of the intersection is represented by the extended part that is extended from each of the front side member part and the cross-member part, and the recessed portion is formed in the extended part. This makes it possible to install the motor unit in a space between the right and left front side member parts and thereby further improve the space efficiency.

In the vehicle body structure configured as described above, the extended part may have a substantially triangular shape.

In the vehicle body structure configured as described above, since the extended part has a substantially triangular shape, a space for the region where the recessed portion is formed can be reduced to further improve the space efficiency.

In the vehicle body structure of the above-described first aspect, the protruding portion may be press-fitted in the recessed portion.

In the vehicle body structure configured as described above, since the protruding portion is press-fitted in the recessed portion, the motor unit can be efficiently prevented from falling in a frontal collision of the vehicle.

In the vehicle body structure of the above-described first aspect, the recessed portion may face the protruding portion across a gap.

In the vehicle body structure configured as described above, in a frontal collision of the vehicle, the support portion supports only the protruding portion, and not the entire motor unit that is a relatively large component, which allows greater positional flexibility in providing the support portion.

A second aspect of the present disclosure relates to a vehicle body structure including a motor unit and a framework member. The motor unit is configured to be supplied with electricity and output a driving force for traveling. The framework member is integrally molded by die-casting and constitutes a framework of a vehicle, the framework member including a support portion that is placed on a rear portion side in a vehicle front-rear direction of the motor unit and configured to support a portion of the motor unit. The motor unit has a flat face that faces the support portion. The support portion is configured to support the motor unit by coming into contact with the flat face in a frontal collision.

In the vehicle body structure of the above-described second aspect, in a frontal collision of the vehicle, the support portion supports the motor unit by coming into contact with the flat face that is provided in the motor unit and faces the support portion. In a frontal collision, therefore, a load is applied to the motor unit from the vehicle front side, while the flat face is supported by the support portion from the vehicle rear side. Thus, the motor unit is pressed from both sides in the vehicle front-rear direction, which can prevent the motor unit from falling in a frontal collision of the vehicle.

As has been described above, the vehicle body structure according to the present disclosure has excellent advantages in that it can reduce the likelihood that a component placed in front of the motor unit in the vehicle front-rear direction may fail to be completely crushed in a frontal collision of the vehicle, and can also reduce the restrictions on the installed size of the battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view schematically showing a vehicle front structure that is one example of a vehicle body structure according to a first embodiment of the present disclosure;

FIG. 2 is a perspective view schematically showing one example of section II-II of FIG. 1 as seen from an obliquely left front side;

FIG. 3 is a partially enlarged horizontal sectional view of engaging portions of FIG. 2;

FIG. 4 is a side view schematically showing a positional relationship between a motor unit and a battery in the vehicle front structure of FIG. 1;

FIG. 5 is a horizontal sectional view corresponding to FIG. 3, showing a modified example of the engaging portions;

FIG. 6 is a partially enlarged perspective view schematically showing a portion of a motor unit included in a vehicle body structure according to a second embodiment of the present disclosure;

FIG. 7 is a perspective view, corresponding to FIG. 2, in the vehicle body structure according to the second embodiment of the present disclosure;

FIG. 8 is a side view schematically showing a positional relationship between the motor unit and a battery in the vehicle body structure according to the second embodiment of the present disclosure;

FIG. 9 is a side view schematically showing a motor unit and a battery in a vehicle body structure according to a third embodiment of the present disclosure; and

FIG. 10 is a side view schematically showing a conventional positional relationship between a motor unit and a battery.

### DETAILED DESCRIPTION OF EMBODIMENTS

In the following, a vehicle body structure according to a first embodiment of the present disclosure will be described with reference to the accompanying drawings. Note that, in the present specification and the drawings, constituent elements having substantially the same functional configuration are designated by the same reference sign to omit redundant description. In addition, arrow FR shown as appropriate in each drawing indicates a front side in a vehicle front-rear direction, and arrow UP indicates an upper side in a vehicle-height direction. Arrow RH indicates a right side in a vehicle-width direction. Unless otherwise noted, when directions of simply front-rear, up-down, right-left, and an inner side and an outer side are used in the following description, these directions indicate front-rear in the vehicle front-rear direction, up-down in the vehicle-height direction, right-left in a vehicle right-left direction (vehicle-width direction), and the inner side and the outer side in the vehicle-width direction.

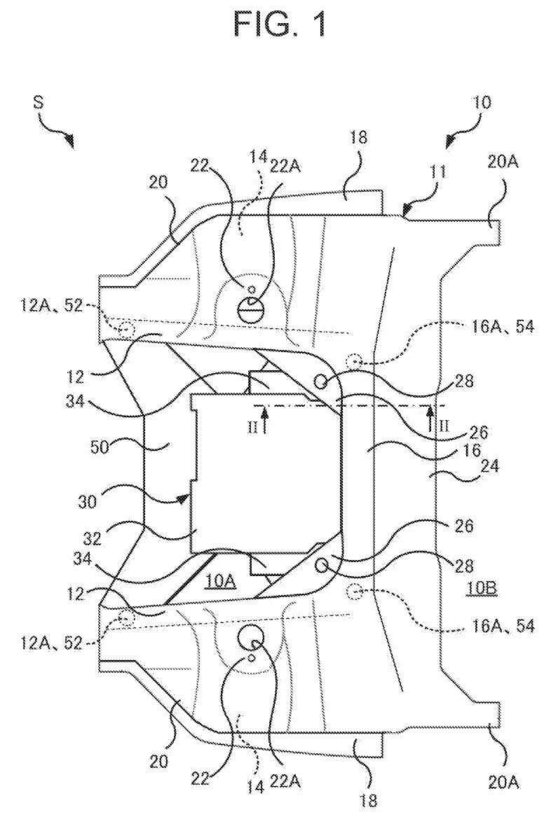

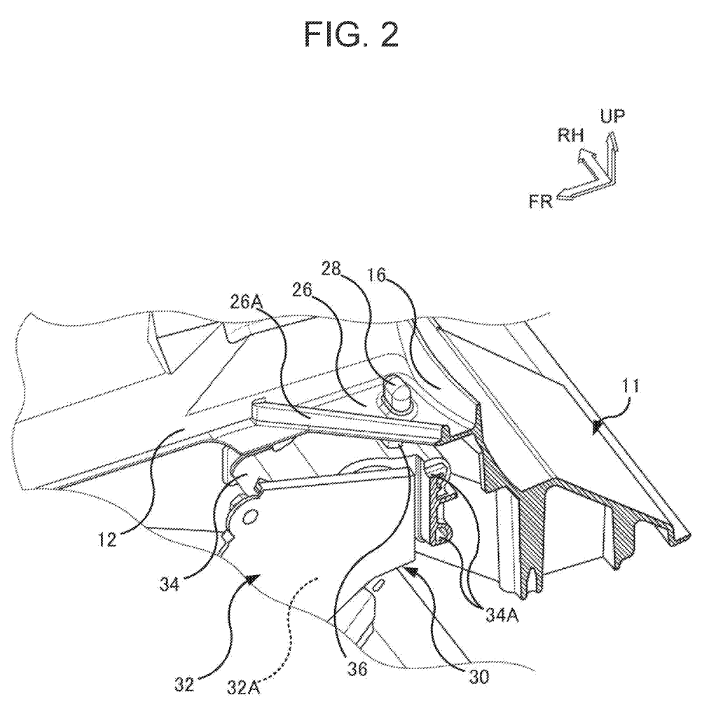

FIG. 1 is a plan view schematically showing a front structure S of a vehicle 10 that is one example of a vehicle body structure according to the first embodiment, and FIG. 2 is a perspective view schematically showing one example of section II-II of FIG. 1 as seen from an obliquely left front side. While FIG. 2 shows a structure of a side portion in a right front part of the vehicle 10, description of a structure of a side portion in a left front part will be omitted, as the structure is basically bilaterally symmetrical. In the first embodiment, the vehicle 10 is, as one example, a battery electric vehicle, a fuel cell electric vehicle, or the like that travels by means of a motor unit 30 as a travel driving source that is supplied with electricity and outputs a driving force for traveling.

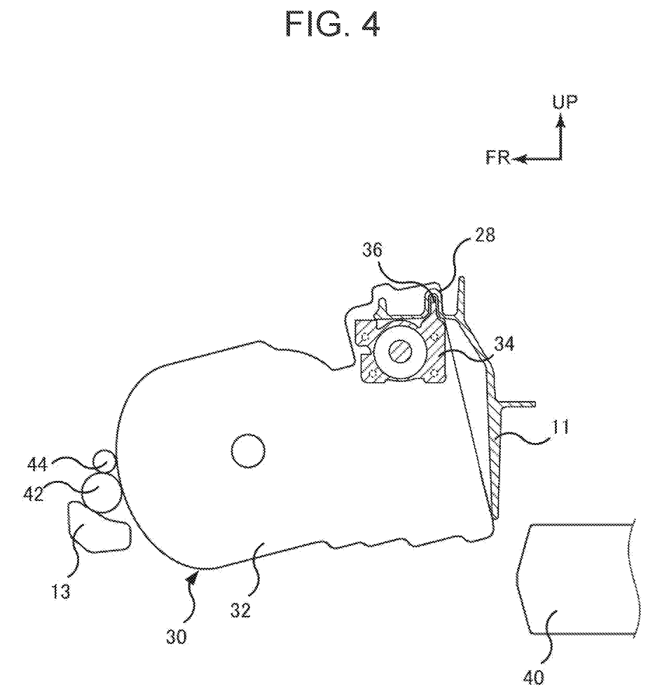

As shown in FIG. 1, the front structure S of the vehicle 10 includes a vehicle-body-front framework body 11 that is a framework member on the front side of the vehicle 10, and the vehicle-body-front framework body 11 includes a pair of right and left front side member parts 12 that is disposed on both sides in the vehicle-width direction of a vehicle front part. The front side member parts 12 are extended in the vehicle front-rear direction, and rear end portions in the vehicle front-rear direction of the front side member parts 12 are connected to a cross-member part 16. Front end portions in the vehicle front-rear direction of the front side member parts 12 are connected to a front bumper reinforcement part (hereinafter referred to as a "bumper RF part") 13 (see FIG. 4) that is disposed along the vehicle-width direction. In the first embodiment, as one example, the front side member parts 12 each have a crush box part (not shown) as an energy absorbing member at the front end portion connected to the bumper RF part 13.

Wheel arch parts 14 in which front wheels (not shown) are disposed are respectively provided on the outer sides in the vehicle-width direction of the front side member parts 12, and the right and left wheel arch parts 14 are connected to each other by the cross-member part 16. In other words, the cross-member part 16 is suspended between the right and left wheel arch parts 14.

Apron upper member parts 18 are respectively disposed on the outer sides in the vehicle-width direction, on the upper sides in the vehicle-height direction, of rear-side portions of the right and left front side member parts 12. The apron upper member parts 18 are framework members constituting frameworks on upper lateral sides in the vehicle-body-front framework body 11, and, like the front side member parts 12, are extended in the vehicle front-rear direction. The front side member parts 12 and the apron upper member parts 18 have a substantially rectangular open cross-sectional shape, with openings provided on the outer sides in the vehicle-width direction, in other words, a substantially rectangular cross-sectional shape that opens on the outer sides in the vehicle-width direction. While this is not shown, the front side member parts 12 and the apron upper member parts 18 each include, as one example, an impact absorbing structure inside the opening.

A pair of right and left fender apron parts 20 is disposed on the outer sides in the vehicle-width direction of the front side member parts 12, on the inner sides in the vehicle-width direction of the apron upper member parts 18. Upper ends of the fender apron parts 20 are respectively joined to the apron upper member parts 18 and lower ends thereof are respectively joined to the front side member parts 12, and each fender apron part 20 is integrally formed with a suspension tower part 22 and the wheel arch part 14. The suspension tower part 22 is provided on the outer side in the vehicle-width direction of the front side member part 12, above the front side member part 12 in the vehicle height direction, and a lower-side portion in the vehicle height direction of the suspension tower part 22 is joined to the fender apron part 20. A through-hole 22A is provided in an upper end face of the suspension tower part 22, and an upper end portion of a shock absorber (not shown) is inserted through the through-hole 22A. The fender apron part 20 is formed so as to bulge toward the inner side in the vehicle-width direction, and this bulging portion forms the wheel arch part 14 in which the front wheel (not shown) is turnably housed.

A dashboard panel part 24 is disposed on the vehicle rear side of the front side member parts 12, between the right and left apron upper member parts 18. The dashboard panel part 24 is a member that separates a motor unit room 10A in which the motor unit 30 is housed and a vehicle cabin 10B from each other, and is extended in the vehicle-width direction and the vehicle-height direction, with its plate thickness direction oriented in the vehicle front-rear direction. End portions in the vehicle-width direction of the dashboard panel part 24 are connected to the fender apron parts 20, and an upper end portion thereof is connected to the cross-member part 16.

A rear end portion 20A of the fender apron part 20 behind the wheel arch part 14 in the vehicle front-rear direction is connected to a rocker part (not shown) that is extended along the vehicle front-rear direction and constitutes a framework of a vehicle body side portion.

The suspension tower part 22 is provided so as to protrude in a substantially tubular shape from the wheel arch part 14 of the fender apron part 20 toward the vehicle upper side. Inside the suspension tower part 22, the shock absorber and a spring are housed that constitute a suspension (not shown) that supports the front wheel housed in the wheel arch part 14.

In the first embodiment, as shown in FIG. 1 and FIG. 2, the vehicle-body-front framework body 11 includes, at corner portions on the front side in the vehicle front-rear direction formed by the front side member parts 12 and the cross-member part 16, substantially triangular extended parts 26 that are each extended from an inner face in the vehicle-width direction of the front side member part 12 toward the inner side and extended from a front-side face in the vehicle front-rear direction of the cross-member part 16 toward the front side.

As shown in FIG. 2, the extended part 26 includes, at its oblique side on the front side in the vehicle front-rear direction, a wall portion 26A that is protruded toward the vehicle upper side. A front-end portion in the vehicle front-rear direction of the wall portion 26A is joined to the front side member part 12, and a rear end portion in the vehicle front-rear direction thereof is joined to the cross-member part 16. The extended part 26 includes, at a central portion, an engaging portion 28 that is protruded in a substantially elliptical shape toward the vehicle upper side and that engages with a protruding portion 36, to be described later, of the motor unit 30. In the first embodiment, the engaging portion 28 corresponds to a support portion. Here, "engaging" is a broad concept covering fitting, contact, locking, arrangement with a small clearance left between the two, etc.

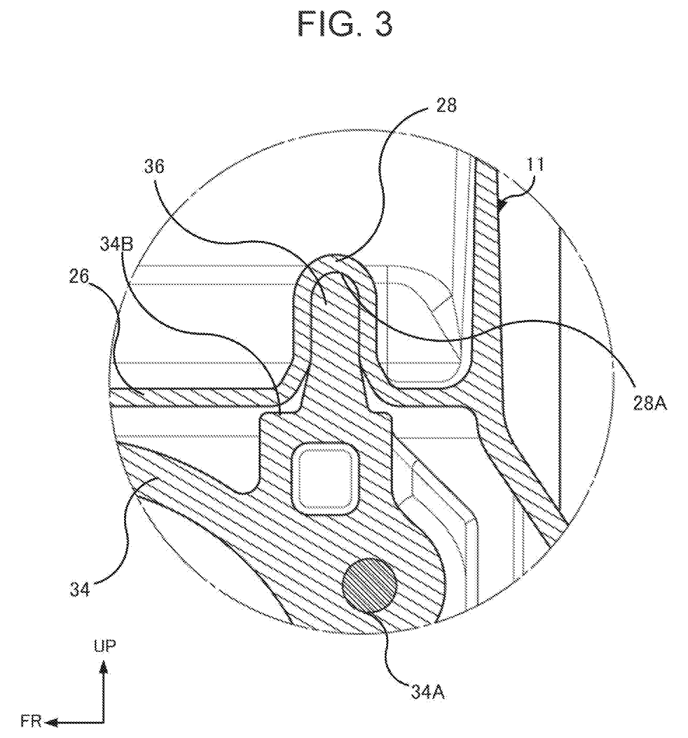

FIG. 3 is a partially enlarged horizontal sectional view of the engaging portion 28. As shown in FIG. 2 and FIG. 3, the engaging portion 28 is formed in a shape large enough to house the protruding portion 36 to be described later, and is formed by protruding the central portion of the extended part 26 toward the vehicle upper side in a concave shape. That is, as shown in FIG. 3, the engaging portion 28 includes a recessed portion 28A which opens on the lower side that is the lower side and in the vehicle-height direction and in which the protruding portion 36 is fitted. An inner face of the recessed portion 28A has substantially the same shape as a leading end of the protruding portion 36. In the recessed portion 28A, the protruding portion 36 is press-fitted to such an extent that the protruding portion 36 can be supported from the upper side.

The vehicle-body-front framework body 11 that is one constituent element of the front structure S of the vehicle 10 of the first embodiment is, as one example, integrally molded by aluminum die-casting so as to include the front side member parts 12, the wheel arch parts 14, the cross-member part 16, the apron upper member parts 18, the fender apron parts 20, the suspension tower parts 22, the dashboard panel part 24, the extended parts 26, and the engaging portions 28 (including the recessed portions 28A) shown in FIG. 1. The bumper RF part 13 may or may not be integrally molded with the vehicle-body-front framework body 11. The front structure S of the vehicle 10 includes, under the front side member parts 12, a front suspension member part (not shown) that supports a front suspension (not shown).

In the first embodiment, the motor unit 30 is placed in the motor unit room 10A that is a space surrounded by the front side member parts 12, the wheel arch parts 14, the cross-member part 16, the apron upper member parts 18, the fender apron parts 20, the suspension tower parts 22, the dashboard panel part 24, etc. The motor unit 30 is placed under the extended parts 26 in the vehicle-height direction.

Here, the motor unit 30 will be described. FIG. 4 is a side view schematically showing a positional relationship between the motor unit 30 and a battery 40. In FIG. 4, the vehicle-body-front framework body 11 and a bracket 34 constituting parts of the front structure S of the vehicle 10 are shown in a horizontal sectional view. As shown in FIG. 4, the motor unit 30 is disposed at a different position from the battery 40 in the vehicle front-rear direction as seen in a vehicle side view. In other words, the motor unit 30 is disposed so as not to overlap the battery 40 as seen in a vehicle side view.

The bumper RF part 13 that is a part of the vehicle-body-front framework body 11 is placed in front of the motor unit 30 in the vehicle front-rear direction as seen in a vehicle side view, and a steering gear box 42 is placed behind the bumper RF part 13 in the vehicle front-rear direction, at an upper portion thereof. A stabilizer 44 that inhibits rolling during turning is placed on the upper side of the steering gear box 42. These bumper RF part 13, steering gear box 42, stabilizer 44, etc., are components that are placed in front of the motor unit 30 in the vehicle front-rear direction.

The motor unit 30 is configured to include a motor (not shown) that is driven by being supplied with electricity from the battery 40 and a motor housing 32 that houses the motor. The motor housing 32 does not necessarily need to be bilaterally symmetrical.

As shown in FIG. 1 and FIG. 2, the motor unit 30 placed as described above includes the brackets 34 respectively on rear portions of side faces 32A on both end sides in the vehicle-width direction. The bracket 34 has a substantially quadrangular shape, and, as one example, a principal face thereof with a larger area is mounted on the side face 32A such that a longitudinal direction thereof is oriented in the vehicle front-rear direction. As one example, the bracket 34 has mounting holes 34A, for example, at four corners, and the side face 32A has, for example, four mounting holes (not shown) at positions corresponding to the mounting holes 34A. The side face 32A of the motor housing 32 has, as one example, a step in the vehicle-width direction; in FIG. 2, therefore, a portion of the side face 32A corresponding to the positions of the mounting holes 34A on the rear side in the vehicle front-rear direction is not shown. Screws (not shown) are screwed into the mounting holes 34A of the bracket 34 and the mounting holes of the side face 32A to thereby mount the bracket 34 onto the side face 32A. The bracket 34 is mounted so as to be located under the extended part 26 in the vehicle-height direction.

As shown in FIG. 2 and FIG. 3, the bracket 34 includes the protruding portion 36 that protrudes upward at a rear portion of an upper face 34B on the upper side in the vehicle-height direction. That is, the protruding portion 36 is protruded toward the extended part 26 and fitted in the recessed portion 28A. The protruding portion 36 is protruded so as to have a substantially elliptical cross-sectional shape, with a leading end having a curved surface as shown in FIG. 3. The protruding portion 36 is formed, as one example, substantially at a center in the vehicle-width direction of the upper face 34B. In the first embodiment, the protruding portion 36 corresponds to an engaging portion on the side of the motor unit 30.

As shown in FIG. 1, as one example, a front end portion of the motor unit 30 is fixed on the front side member parts 12 through a motor mount 50. As one example, a rear end portion of the motor unit 30 is fixed on the cross-member part 16 through the motor mount 50.

In the first embodiment, as one example, the front side member parts 12 each include a front motor mounting portion 12A on the lower side of a front-side portion in the vehicle front-rear direction, and the cross-member part 16 includes rear motor mounting portions 16A on the lower sides of both end portions in the vehicle-width direction. As one example, the motor mount 50 includes, at both end portions in the vehicle-width direction on the front side in the vehicle front-rear direction, front mount portions 52 respectively corresponding to the front motor mounting portions 12A, and includes, at both end portions in the vehicle-width direction on the rear side in the vehicle front-rear direction, rear mount portions 54 respectively corresponding to the rear motor mounting portions 16A.

A front end-side portion of the motor unit 30 is fixed on the front motor mounting portions 12A of the respective front side member parts 12 through the right and left front mount portions 52 of the motor mount 50. A rear end-side portion of the motor unit 30 is fixed on the front motor mounting portions 12A of the cross-member part 16 on both sides of the vehicle through the right and left rear mount portions 54 of the motor mount 50. To fix the motor mount 50 to the front side member parts 12 and the cross-member part 16, bolt fastening or the like can be used. When seen from the vehicle-height direction, the motor unit 30 is disposed between the front side member parts 12.

Next, the workings and advantages of the first embodiment will be described.

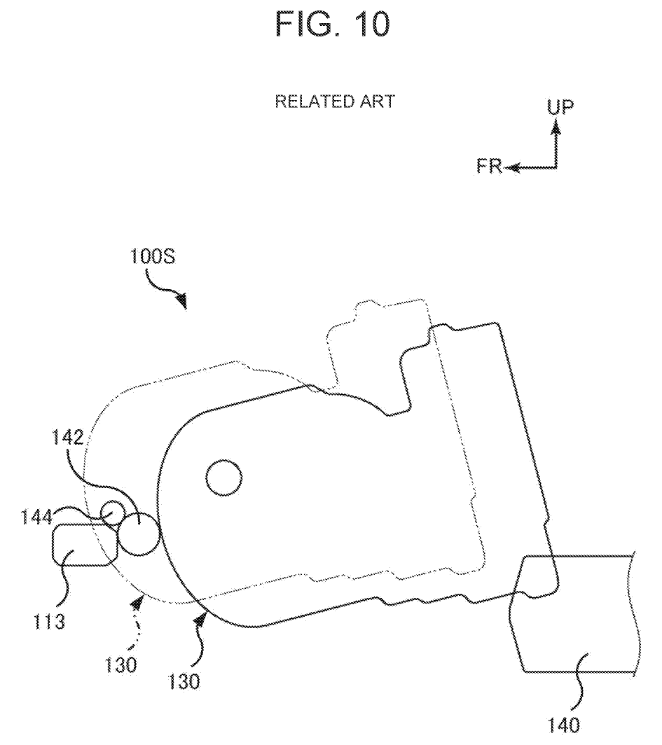

FIG. 10 is a side view schematically showing a conventional positional relationship between a motor unit 130 and a battery 140. In FIG. 10, a front structure 100S of a conventional vehicle is shown, and as shown in FIG. 10, in the front structure 100S, before a frontal collision of the vehicle, the motor unit 130 is disposed at the position indicated by the long dashed double-short dashed line, i.e., a different position from the battery 140 in the vehicle front-rear direction as seen in a vehicle side view, so as not to overlap the battery 140.

In front of the motor unit 130 in the vehicle front-rear direction as seen in a vehicle side view, a bumper RF part 113 and components placed in front of the motor unit 130, such as a steering gear box 142 and a stabilizer 144, are placed as in the positional relationship shown in FIG. 4.

In the vehicle in which the motor unit 130 and the battery 140 are placed in the positional relationship shown in FIG. 10, when a frontal collision occurs, the motor unit 130 moves backward and falls as indicated by the solid line in FIG. 10. If the motor unit 130 moves backward and falls, the aforementioned components that are placed in front of the motor unit 130 in the vehicle front-rear direction also move backward, so that these components may fail to be completely crushed. To prevent the motor unit 130 from colliding with the battery 140 as shown in FIG. 10 in a frontal collision, an interval of a certain length is needed between the battery 140 and the motor unit 130 from a safety viewpoint, which puts restrictions on the installed size of the battery 140.

In the front structure S of the vehicle 10 according to the first embodiment, as described above, the vehicle-body-front framework body 11 as the framework member that is integrally molded by die-casting and has the framework of the vehicle 10 includes, on the rear portion side of the motor unit 30, the engaging portions 28 as the support portions that each support a portion of the motor unit 30. The motor unit 30 includes, as the engaging portions that engage with the engaging portions 28, the protruding portions 36 that protrude toward the extended parts 26 that are parts of the framework member. The engaging portions 28 of the vehicle-body-front framework body 11 each include the recessed portion 28A in which the protruding portion 36 is fitted.

Therefore, as the protruding portions 36 are fitted in the recessed portions 28A of the engaging portions 28 at the rear portions of the motor unit 30, the motor unit 30 is supported by the engaging portions 28. Thus, as the protruding portions 36 of the motor unit 30 are fitted in the recessed portions 28A of the support portions at the rear portions of the motor unit 30, the motor unit 30 can be efficiently prevented from falling in a frontal collision of the vehicle 10. Further, since the protruding portions 36 that are portions of the motor unit 30 are supported by the recessed portions 28A, the motor unit 30 can be prevented from moving backward in a frontal collision of the vehicle 10. In a frontal collision of the vehicle 10, a load is input from the vehicle front side into the protruding portions 36 fitted in the recessed portions 28A of the engaging portions 28, and at the same time the protruding portions 36 are pressed against rear faces of the recessed portions 28A. That is, the protruding portions 36 are pressed from both sides in the vehicle front-rear direction. Thus, the protruding portions 36 are held in the recessed portions 28A from both sides, which can prevent the motor unit 30 from falling.

As the rear portions of the motor unit 30 are thus supported by the engaging portions 28, a reaction force can be generated by the motor unit 30, which can reduce the likelihood that the components placed in front of the motor unit 30 may fail to be completely crushed. That the motor unit 30 does not move backward allows the interval between the battery 40 and the motor unit 30 to be shortened and can thereby reduce the restrictions on the installed size of the battery.

In the front structure S of the vehicle 10 according to the first embodiment, since the protruding portions 36 are press-fitted in the recessed portions 28A, the motor unit 30 can be efficiently prevented from falling in a frontal collision of the vehicle 10.

In the front structure S of the vehicle 10 according to the first embodiment, the recessed portions 28A that open on the lower side in the vehicle-height direction are fitted on the protruding portions 36 that protrude toward the upper side in the vehicle-height direction. Thus, the motor unit 30 can be supported from the upper side in the vehicle-height direction to prevent the motor unit 30 from falling in a frontal collision of the vehicle 10.

In the front structure S of the vehicle 10 according to the first embodiment, since the recessed portions 28A are respectively provided on both sides in the vehicle-width direction of the vehicle-body-front framework body 11, the vehicle-body-front framework body 11 can support the motor unit 30 in a well-balanced manner.

In the front structure S of the vehicle 10 according to the first embodiment, since the recessed portions 28A are provided at sites where the front side member parts 12 and the cross-member part 16 intersect, the motor unit 30 can be installed in the space between the right and left wheel arch parts 14 to improve the space efficiency. Since the recessed portions 28A can be provided at corner portions in the space region surrounded by the front side member parts 12 and the cross-member part 16, the motor unit 30 can be supported in a region where it does not interfere with other member parts.

In the front structure S of the vehicle 10 according to the first embodiment, the sites of the intersection are represented by the extended parts 26 that are each extended from each of the front side member part 12 and the cross-member part 16, and the recessed portions 28A are formed in the extended parts 26. This makes it possible to install the motor unit 30 in the space between the right and left front side member parts 12 and thereby further improve the space efficiency.

In the front structure S of the vehicle 10 according to the first embodiment, since the extended parts 26 have a substantially triangular shape, a space for each region where the recessed portion 28A is formed can be reduced to further improve the space efficiency.

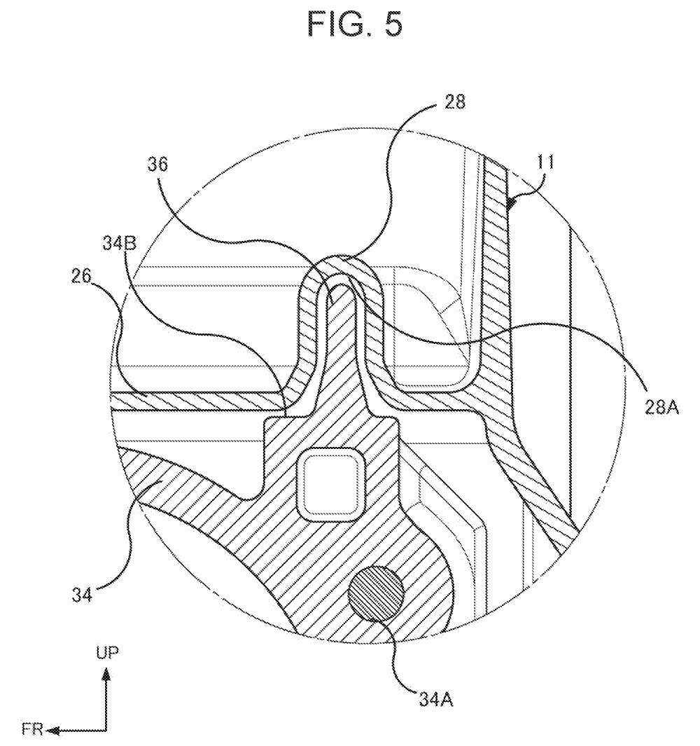

In the above-described first embodiment, "fitting" includes a state where there is a clearance between the two as in clearance fitting. That is, while in the above-described first embodiment the protruding portions 36 are press-fitted in the recessed portions 28A under normal conditions before the vehicle 10 is subjected to a frontal collision, the present disclosure is not limited thereto. FIG. 5 is a horizontal sectional view corresponding to FIG. 3, showing a modified example of the engaging portion 28.

As shown in FIG. 5, in the modified example, the protruding portion 36 is not press-fitted in the recessed portion 28A, and the recessed portion 28A and the protruding portion 36 are fitted in a state where there is a clearance therebetween, i.e., by clearance fitting.

Also when the protruding portion 36 is thus fitted in the recessed portion 28A by clearance fitting, in a frontal collision of the vehicle 10, a load is input from the vehicle front side into the protruding portion 36 fitted in the recessed portion 28A, and at the same time the protruding portion 36 is pressed against the rear face of the recessed portion 28A, which can prevent the motor unit 30 from moving backward in a frontal collision of the vehicle 10. Moreover, in a frontal collision of the vehicle 10, the protruding portion 36 is pressed against a front face of the recessed portion 28A, so that the protruding portion 36 is pressed from both sides in the vehicle front-rear direction. Thus, the protruding portion 36 is held in the recessed portion 28A from both sides, which can prevent the motor unit 30 from falling.

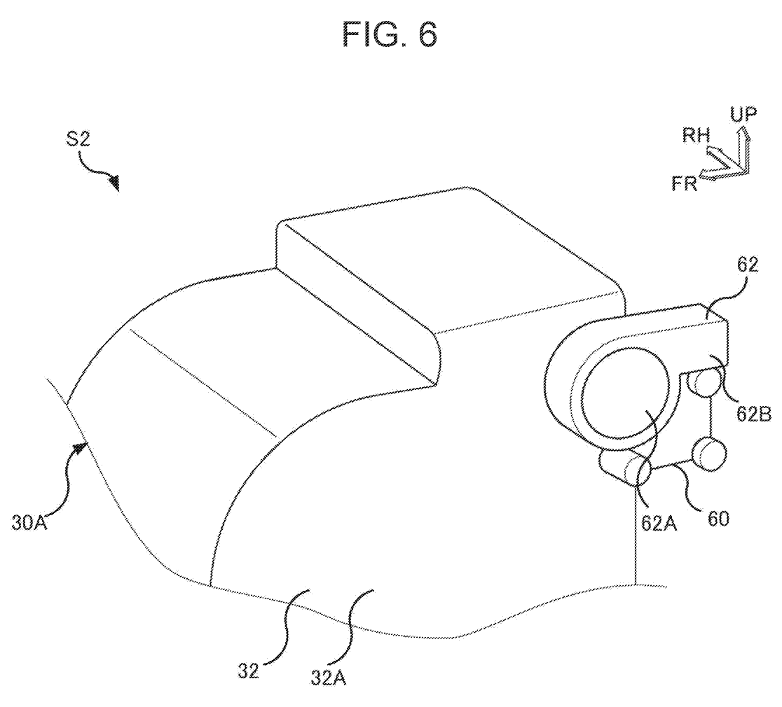

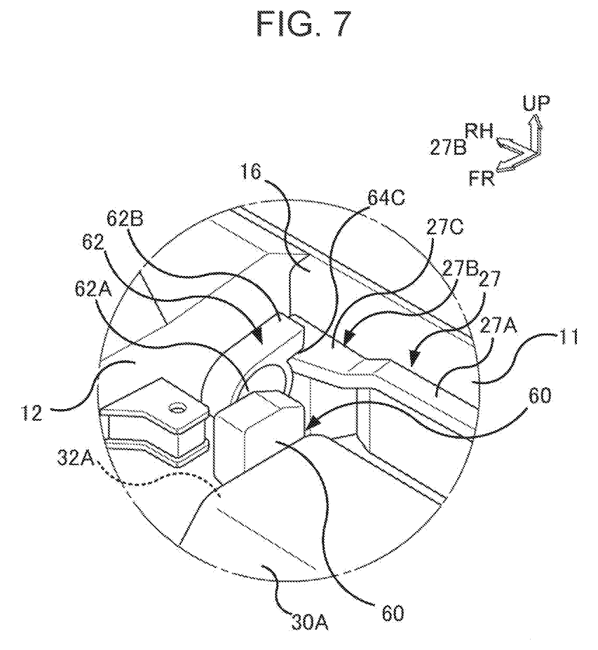

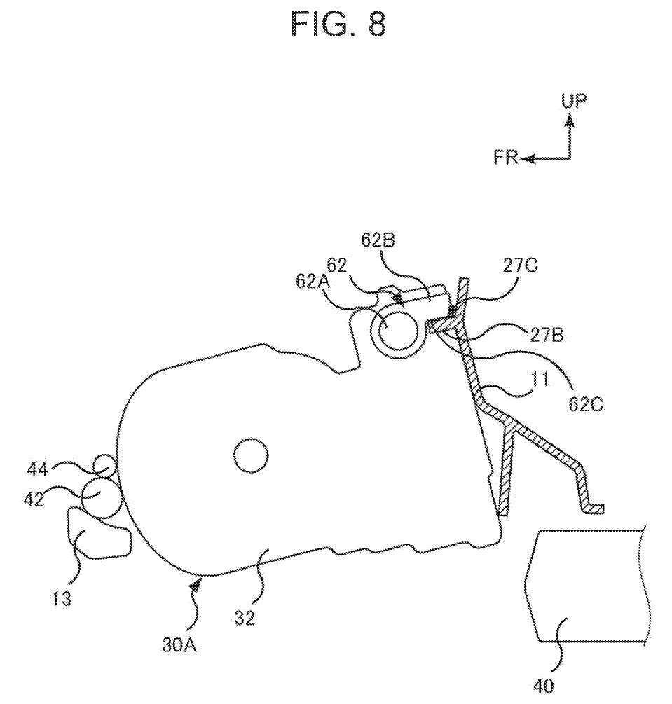

Next, a front structure S2 of the vehicle 10 according to a second embodiment of the present disclosure will be described. FIG. 6 is a partially enlarged perspective view schematically showing a portion of a motor unit 30A included in the front structure S2 of the vehicle 10 according to the second embodiment; FIG. 7 is a perspective view corresponding to FIG. 2 in the front structure S2 of the vehicle 10 according to the second embodiment; and FIG. 8 is a side view schematically showing a positional relationship between the motor unit 30A and the battery 40 in the front structure S2 of the vehicle 10 according to the second embodiment.

Those parts of the front structure S2 of the vehicle 10 according to the second embodiment that have the same configuration as in the foregoing description of the first embodiment will be designated by the same numbers and description thereof will be omitted. For the convenience of description, a second bracket 60 shown in FIG. 6 is mounted on the left side face 32A of the motor unit 30A, and the second bracket 60 shown in FIG. 7 is mounted on the right-side face 32A of the motor unit 30A.

As shown in FIG. 6, in the front structure S2 of the vehicle 10 of the second embodiment, the motor unit 30A includes the second bracket 60 in place of the bracket 34 of the above-described first embodiment. As shown in FIG. 6 and FIG. 7, the motor unit 30A includes the second brackets 60 respectively at rear portions of the side faces 32A on both end sides in the vehicle-width direction. The second bracket 60 has a substantially rectangular shape, and, as one example, a principal face thereof with a larger area is mounted on the side face 32A. As one example, the second bracket 60 has mounting holes (not shown) at four corners as with the bracket 34 of the above-described first embodiment, and the side face 32A has, for example, four mounting holes (not shown) at positions corresponding to these mounting holes. Screws (not shown) are screwed into the mounting holes of the second bracket 60 and the side face 32A to thereby mount the second bracket 60 onto the side face 32A.

As shown in FIG. 6, a supported portion 62 is mounted on a principal face of the second bracket 60 on the opposite side from the motor housing 32. The supported portion 62 may be integrally formed with the second bracket 60, or may be formed as a separate part. When the supported portion 62 is formed as a separate part, the supported portion 62 and the second bracket 60 may be fastened together with a screw, or may be mounted using an adhesive, welding, etc.

The supported portion 62 includes a mounted portion 62A that has a substantially circular shape and mounted to the second bracket 60, and a second protruding portion 62B that is protruded in a rectangular columnar shape from the mounted portion 62A toward the vehicle rear side. As shown in FIG. 7 and FIG. 8, the second protruding portion 62B is protruded toward the cross-member part 16 that is a part of the vehicle-body-front framework body 11.

As shown in FIG. 7, the vehicle-body-front framework body 11 of the second embodiment includes a support portion-side protruding portion 27 as a support portion that protrudes from a front-side face in the vehicle front-rear direction of the cross-member part 16 toward the vehicle front side. The support portion-side protruding portion 27 includes a central extended portion 27A that is extended from a central portion in the vehicle-width direction toward the outer side in the vehicle-width direction, and an extended end portion 27B that is extended toward the outer side in the vehicle-width direction after descending one level from an end portion of the central extended portion 27A toward the lower side near the position in the vehicle-width direction where the second bracket 60 is located. The support portion-side protruding portion 27 including the central extended portion 27A and the extended end portion 27B are protruded in a plate shape.

The support portion-side protruding portion 27 and the second protruding portion 62B configured as described above are spaced apart from each other under normal conditions before the vehicle 10 is subjected to a frontal collision. That is, under normal conditions before the vehicle 10 is subjected to a frontal collision, an upper face 27C of the support portion-side protruding portion 27 and a lower face 62C of the second protruding portion 62B are spaced apart from each other. As one example, the upper face 27C of the support portion-side protruding portion 27 and at least a portion of the lower face 62C of the second protruding portion 62B are spaced apart from and face each other in the vehicle-height direction. In other words, as seen from the vehicle front side, the upper face 27C of the support portion-side protruding portion 27 and the lower face 62C of the second protruding portion 62B are spaced apart from and face each other in the vehicle-height direction such that the former is located under the latter. In a frontal collision of the vehicle 10, as shown in FIG. 7 and FIG. 8, the support portion-side protruding portion 27 supports the second protruding portion 62B from the vehicle lower side as the upper face 27C thereof engages with the lower face 62C of the second protruding portion 62B.

Next, the workings and advantages of the second embodiment will be described.

In the front structure S2 of the vehicle 10 according to the second embodiment, the second protruding portion 62B is supported by the support portion-side protruding portion 27 in a frontal collision of the vehicle 10. Thus, the support portion-side protruding portion 27 supports only the second protruding portion 62B, and not the entire motor unit 30A that is a relatively large component, which allows greater positional flexibility in providing the support portion-side protruding portion 27.

In the front structure S2 of the vehicle 10 according to the second embodiment, in a frontal collision of the vehicle 10, the support portion-side protruding portion 27 supports from the vehicle lower side the second protruding portion 62B that protrudes toward the support portion-side protruding portion 27. Thus, the motor unit 30A can be prevented from falling in a frontal collision of the vehicle 10.

In the front structure S2 of the vehicle 10 according to the second embodiment, in a frontal collision of the vehicle 10, the upper face 27C of the extended end portion 27B of the support portion-side protruding portion 27 protruding toward the vehicle front side engages with the lower face 62C of the second protruding portion 62B protruding toward the vehicle rear side. Thus, as the support portion-side protruding portion 27 can support the second protruding portion 62B from the vehicle lower side, the motor unit 30A can be prevented from falling in a frontal collision of the vehicle 10.

In the front structure S2 of the vehicle 10 according to the second embodiment, the support portion-side protruding portion 27 is provided on the cross-member part 16 suspended between the right and left wheel arch parts 14. Thus, the motor unit 30A can be installed in the space between the right and left wheel arch parts 14, which can improve the space efficiency.

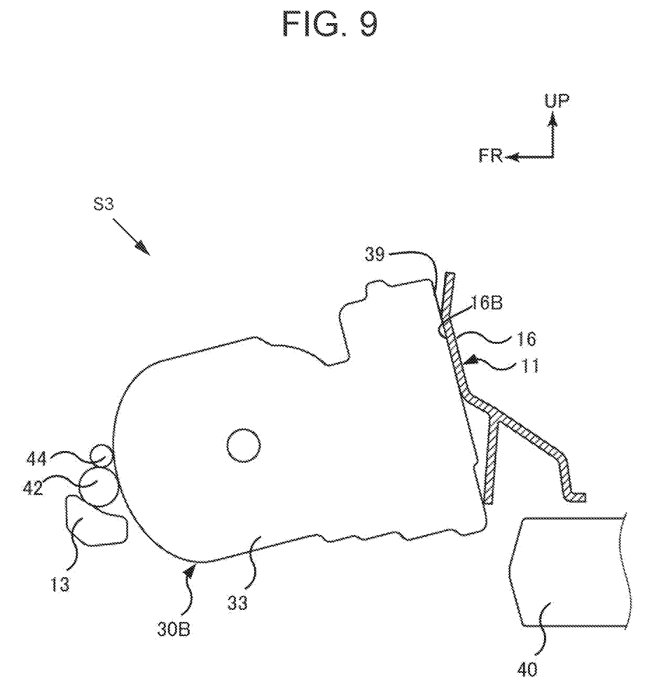

Next, a front structure S3 of the vehicle 10 as a vehicle body structure according to a third embodiment of the present disclosure will be described. FIG. 9 is a side view schematically showing a motor unit 30B and the battery 40 in the front structure S3 of the vehicle 10 according to the third embodiment. Those parts in the front structure S3 of the vehicle 10 according to the third embodiment that have the same configuration as in the foregoing description of the first embodiment will be designated by the same numbers and description thereof will be omitted.

In the front structure S3 of the vehicle 10 according to the third embodiment, a motor housing 33 of the motor unit 30B has, on the rear side in the vehicle front-rear direction, i.e., on the side closer to the cross-member part 16, a flat face 39 that is spaced apart from and faces the cross-member part 16. In the third embodiment, a front face 16B on the front side in the vehicle front-rear direction of the cross-member part 16 corresponds to a support portion. In a frontal collision of the vehicle 10, the front face 16B supports the motor unit 30B by coming into contact with the flat face 39.

Next, the workings and advantages of the third embodiment will be described.

In the front structure S3 of the vehicle 10 according to the third embodiment, in a frontal collision of the vehicle 10, the front face 16B on the front side in the vehicle front-rear direction of the cross-member part 16 supports the motor unit 30B by coming into contact with the flat face 39 that is provided in the motor unit 30B and faces the front face 16B. In a frontal collision, therefore, a load is applied to the motor unit 30B from the vehicle front side, while the flat face 39 is supported by the front face 16B of the cross-member part 16 from the vehicle rear side. Thus, the motor unit 30B is pressed from both sides in the vehicle front-rear direction, which can prevent the motor unit 30B from falling in a frontal collision of the vehicle 10.

Here, a supplementary description will be given. In the above-described first embodiment, the protruding portion 36 is protruded from the bracket 34, but the present disclosure is not limited thereto. For example, the protruding portion 36 may be formed as a separate part from the bracket 34, and the protruding portion 36 may be mounted to the bracket 34.

In the above-described first embodiment, the protruding portion 36 protrudes toward the upper side in the vehicle-height direction and the recessed portion 28A opens on the lower side in the vehicle-height direction, but the present disclosure is not limited thereto. For example, the protruding portion 36 may protrude toward the outer side of the vehicle, and the recessed portion 28A may be provided on the inner side of the front side member part 12 so as to open on the inner side of the vehicle.

In the first embodiment and the second embodiment described above, in a frontal collision of the vehicle 10, the engaging portion 28 as the support portion and the support portion-side protruding portion 27 as the support portion support the protruding portion 36 and the second protruding portion 62B, respectively, provided at the rear portions in the vehicle front-rear direction of the motor units 30, 30A. However, the present disclosure is not limited thereto. For example, when the protruding portion 36 and the second protruding portion 62B are provided on the rear side in the vehicle front-rear direction of the motor units 30, 30A, respectively, i.e., on a rear face of the motor housing 32, these protruding portion 36 and second protruding portion 62B provided on the rear side in the vehicle front-rear direction may be supported.

In the above-described second embodiment, the supported portion 62 including the second protruding portion 62B is mounted on the second bracket 60, but the present disclosure is not limited thereto. For example, the second protruding portion 62B may be mounted on the second bracket 60, or the second bracket 60 and the second protruding portion 62B may be integrally formed.

In the above-described second embodiment, the support portion-side protruding portion 27 is provided along the entire cross-member part 16 in the vehicle-width direction, but the present disclosure is not limited thereto; the support portion-side protruding portion 27 may be provided only in a range corresponding to the second protruding portion 62B.

In the above-described third embodiment, the flat face 39 is provided in the motor housing 32, but the present disclosure is not limited thereto. For example, a member having the flat face 39 may be mounted on the rear-side face of the motor housing 32.

The configuration of the present disclosure is not limited to the above-described first to third embodiments, and the configuration can be changed as appropriate as long as it can solve the problem.

Regarding the above-described first to third embodiments, the following supplement will be further disclosed.

A first aspect of the supplement will be described. A vehicle body structure including:

a motor unit configured to be supplied with electricity and output a driving force for traveling; and a framework member that is integrally molded by die-casting and constitutes a framework of a vehicle, the framework member including a support portion that is placed on the rear side or the rear portion side in the vehicle front-rear direction of the motor unit and that is provided so as to be spaced apart from the motor unit and face the motor unit.

In the vehicle body structure according to the above-described first aspect of the supplement, the framework member that is integrally molded by die-casting and has the framework of the vehicle includes the support portion that is provided on the rear side or the rear portion side in the vehicle front-rear direction of the motor unit so as to be spaced apart from the motor unit and face the motor unit. Thus, since the support portion is included that is provided on the rear side or the rear portion side in the vehicle front-rear direction of the motor unit so as to be spaced apart from the motor unit and face the motor unit, in a frontal collision of the vehicle, the motor unit can be prevented from moving backward as the support portion supports the motor unit. As the motor unit is thus supported on the rear side or the rear portion side in the vehicle front-rear direction of the motor unit, a reaction force can be generated by the motor unit, which can reduce the likelihood that a component placed in front of the motor unit may fail to be completely crushed. That the motor unit does not move backward allows the interval between the battery and the motor unit to be shortened, so that the restrictions on the installed size of the battery can be reduced.

Next, a second aspect of the supplement will be described. The vehicle body structure according to the first aspect, wherein the motor unit and the support portion include engaging portions that engage with each other.

In the vehicle body structure according to the above-described second aspect of the supplement, the motor unit and the support portion include the engaging portions that engage with each other. Thus, in a frontal collision of the vehicle, the motor unit and the support portion engage with each other by the engaging portions, which can efficiently prevent the motor unit from falling in a frontal collision of the vehicle.

Here, "the engaging portions that engage with each other" means that two things are combined into a couple, i.e., are in a state of a pair. In the present disclosure, since the motor unit and the support portion face each other across a gap, the engaging portion on the motor unit side and the engaging portion on the support portion side also face each other across a gap.

Next, a third aspect of the supplement will be described. The vehicle body structure according to the first aspect or the second aspect, wherein:

the motor unit includes a protruding portion that protrudes toward the framework member; and

the support portion faces the protruding portion across a gap.

In the vehicle body structure according to the above-described third aspect of the supplement, in a frontal collision of the vehicle, the support portion supports only the protruding portion, and not the entire motor unit that is a relatively large component, which allows greater positional flexibility in providing the support portion.

Next, a fourth aspect of the supplement will be described. The vehicle body structure according to the third aspect, wherein:

the protruding portion protrudes toward the support portion; and the support portion is provided under the protruding portion in the vehicle-height direction, at a position where it overlaps the protruding portion as seen in a vehicle top view.

In the vehicle body structure according to the above-described fourth aspect of the supplement, in a frontal collision of the vehicle, the support portion supports the protruding portion protruding toward the support portion from the lower side in the vehicle-height direction, which can prevent the motor unit from falling in a frontal collision of the vehicle.

Next, a fifth aspect of the supplement will be described. The vehicle body structure according to the fourth aspect, wherein:

the support portion includes a support portion-side protruding portion that protrudes toward the vehicle front side; and an upper face in the vehicle-height direction of the support portion-side protruding portion faces a lower face in the vehicle-height direction of the protruding portion across a gap.

In the vehicle body structure according to the above-described fifth aspect of the supplement, the upper face of the support portion-side protruding portion protruding toward the vehicle front side faces the lower face of the protruding portion protruding toward the vehicle rear side across a gap. Thus, in a frontal collision of the vehicle, the support portion-side protruding portion can support the protruding portion from the vehicle lower side, which can prevent the motor unit from falling in a frontal collision of the vehicle.

Next, a sixth aspect of the supplement will be described. The vehicle body structure according to the first aspect, wherein:

the motor unit has a flat face that faces the support portion; and the support portion supports the motor unit by coming into contact with the flat face in a frontal collision.

In the vehicle body structure according to the sixth aspect, in a frontal collision of the vehicle, the support portion supports the motor unit by coming into contact with the flat face that is provided in the motor unit and faces the support portion. Thus, in a frontal collision, a load from the vehicle front side is applied to the motor unit, while the flat face is supported by the support portion from the vehicle rear side. Thus, as the motor unit is pressed from both sides in the vehicle front-rear direction, the motor unit can be prevented from falling in a frontal collision of the vehicle.

Next, a seventh aspect of the supplement will be described. The vehicle body structure according to any one of the first aspect to the sixth aspect, wherein:

the framework member is integrally molded so as to include right and left wheel arch parts respectively provided at both ends in the vehicle-width direction and a cross-member part suspended between the right and left wheel arch parts; and the support portion is provided on the cross-member part.

In the vehicle body structure according to the seventh aspect of the supplement, since the support portion is provided on the cross-member part suspended between the right and left wheel arch parts, the motor unit can be installed in the space between the right and left wheel arch parts, which can improve the space efficiency.

What is claimed is:

1. A vehicle body structure comprising:
a motor unit configured to be supplied with electricity and output a driving force for traveling;
a framework member that is integrally molded by die-casting and constitutes a framework of a vehicle, the framework member including a support portion that is placed on a rear portion side in a vehicle front-rear direction of the motor unit and configured to support a portion of the motor unit;
a protruding portion that is provided on the motor unit and protrudes toward the framework member; and
a recessed portion which is provided in the support portion and opens on a side closer to the motor unit, and in which the protruding portion is fitted.

2. The vehicle body structure according to claim 1, wherein:
the protruding portion protrudes toward an upper side in a vehicle-height direction; and
the recessed portion opens on a lower side in the vehicle-height direction.

3. The vehicle body structure according to claim 1, wherein the recessed portion is provided on each side in a vehicle-width direction of the framework member.

4. The vehicle body structure according to claim 3, wherein:
the framework member is integrally molded so as to include a pair of right and left front side member parts respectively provided on both sides in the vehicle-width direction, right and left wheel arch parts respectively provided on outer sides in the vehicle-width direction of rear-side portions in a vehicle front-rear direction of the right and left front side member parts, and a cross-member part suspended between the right and left wheel arch parts; and
the recessed portion is provided at a site where the front side member part and the cross-member part intersect.

5. The vehicle body structure according to claim 4, wherein the site of the intersection is represented by an extended part that is extended from an inner face in the vehicle-width direction of the front side member part toward an inner side and extended from a front end face in the vehicle front-rear direction of the cross-member part toward a front side.

6. The vehicle body structure according to claim 5, wherein the extended part has a substantially triangular shape.

7. The vehicle body structure according to claim 1, wherein the protruding portion is press-fitted in the recessed portion.

8. The vehicle body structure according to claim 1, wherein the recessed portion faces the protruding portion across a gap.

9. A vehicle body structure comprising:
a motor unit configured to be supplied with electricity and output a driving force for traveling; and
a framework member that is integrally molded by die-casting and constitutes a framework of a vehicle, the framework member including a support portion that is placed on a rear portion side in a vehicle front-rear direction of the motor unit and configured to support a portion of the motor unit; wherein
the motor unit has a flat face that faces the support portion; and
the support portion is configured to support the motor unit by coming into contact with the flat face in a frontal collision.
